(19) United States
(12) Patent Application Publication
(10) Pub. No.: US 2009/0036066 A1
(43) Pub. Date: Feb. 5, 2009

(54) Smart data dynamic communication module and message processing and transmitting method thereof

(76) Inventors: Di Chiu, Taipei County (TW); Yuan Yu Chou, Taoyuan County (TW)

Correspondence Address: CHARLES E. BAXLEY, ESQUIRE, 90 JOHN STREET, SUITE 309, NEW YORK, NY, 10038, US

(21) Appl. No.: 12/148,580

(22) Filed: Apr. 21, 2008

(30) Foreign Application Priority Data
Jul. 31, 2007 (TW) 096127911

(51) Int. Cl. H04B 1/38; G06F 15/173

(52) U.S. Cl. 455/90.2; 709/223

(57) ABSTRACT

A smart data dynamic communication module includes a data linking platform and an application platform. The application platform has a position detecting unit, an identification detecting unit, a network unit, a communication transmitting unit and a wireless signal transceiver unit, all of which are communicated with a message control and processing unit. The communication module can provide a position and identification detecting mechanism, a routing table creating mechanism, a data wireless real-time switching mechanism and a path searching and selecting mechanism according to the function of each unit and the arrangements between the units. Consequently, the communication module provides the position detection, the identification detection and the real-time information exchange, transmits the information through an optimum path, and has the effect of preventing the information from being lost.

### BACKGROUND OF THE INVENTION

1. Field of the Invention

The invention relates to a communication module and a message processing and transmitting method thereof, and more particularly to a data dynamic communication module including a data linking platform and an application platform, wherein the application platform has Zigbee and Bluetooth transmission modes and can provide the position detection, the identification detection and the real-time information exchange (through various communication modules), can transmit information through an optimum path, and has a function of preventing the information from being lost.

2. Description of the Related Art

The typical wireless transmission includes the method of transmitting messages for a long distance in, for example, a communication system or a satellite system, and the method of transmitting messages for a short distance in, for example, a Bluetooth module or a Zigbee module. The Zigbee module has the properties of the low power consumption and the simple architecture, and is thus applied to an energy monitoring system or an illumination control system.

For example, Taiwan Patent No. M312640 discloses a wireless signal transmission system of an electric water heater, Taiwan Patent No. I257462 discloses a detection transmission system for monitoring the gas, and Taiwan Patent No. M292669 discloses an automatic control system for immediately monitoring a road lamp, wherein Zigbee transmission modules are used to transmit the messages in these patents. Also, Taiwan Patent No. M288702 discloses a portable storage device for identifying a user, in which the data is transmitted in a wireless manner, such as the Zigbee transmitting manner. It is obtained, from the above-mentioned patents, that the Zigbee module may be combined with various apparatuses.

However, different methods are applied to different apparatuses. Although the Zigbee alliance has specified the Zigbee stacking architecture, the application end is not particularly specified. In other words, when the developer is developing or designing the product, the product requirement and the stacking architecture of the Zigbee module have to be combined together.

### SUMMARY OF THE INVENTION

It is therefore an object of the invention to provide a smart data dynamic communication module, which has the simplified architecture and has an effect of modularizing mechanisms.

Another object of the invention is to provide a message processing and transmitting method of a communication module, which can provide the position detection, the identification detection and the real-time information exchange, can transmit information through an optimum path, and has the effect of preventing the information from being lost.

The invention achieves the above-identified objects by providing a communication module mainly including a data linking platform and an application platform. The application platform has a message control and processing unit, a position detecting unit, an identification detecting unit, a network unit, a communication transmitting unit and a wireless signal transceiver unit. The application platform is constructed in a wireless network platform. The position detecting unit, the identification detecting unit, the network unit, the communication transmitting unit and the wireless signal transceiver unit respectively communicate with the message control and processing unit. Each of the units is firmware, so the communication module has the normal specification and the simplified architecture.

The invention also provides a message processing and transmitting method of a communication module. The message processing and transmitting method mainly includes a position and identification detecting mechanism (or step), a routing table creating mechanism (or step), a data wireless real-time switching mechanism (or step) and a path searching and selecting mechanism (or step). The communication module may provide the position detection, the identification detection and the real-time information exchange, may transmit information through an optimum path, may have an effect of preventing the information from being lost, and is advantageous to a developer in developing a product according to the functions of the mechanisms and the arrangements between the mechanisms.

Further benefits and advantages of the present invention will become apparent after a careful reading of the detailed description with appropriate reference to the accompanying drawings.

### BRIEF DESCRIPTION OF THE DRAWINGS

The above and other objects of the present invention will become readily apparent by reference to the following detailed description when considered in conjunction with the accompanying drawings wherein:

FIG. 1 is a block diagram showing a communication module of the invention;

FIG. 2 is a block diagram showing various mechanisms of the invention;

FIG. 3 is a flow chart showing a position and identification detecting mechanism of the invention;

FIG. 4 is a schematic illustration showing the position and identification detecting mechanism of the invention;

FIG. 5 is a schematic illustration showing a process of adjusting a strength of a reply message according to the invention;

FIG. 6 is a schematic illustration showing a mechanism of creating a routing table according to the invention;

FIG. 7 is a schematic illustration showing a real-time and wireless data switching mechanism according to the invention;

FIG. 8 is a schematic illustration showing a mechanism of searching and selecting a path according to the invention; and

FIG. 9 is a flow chart showing a mechanism of determining a direction and a distance of a to-be-detected end according to the invention.

### DETAILED DESCRIPTION OF THE INVENTION

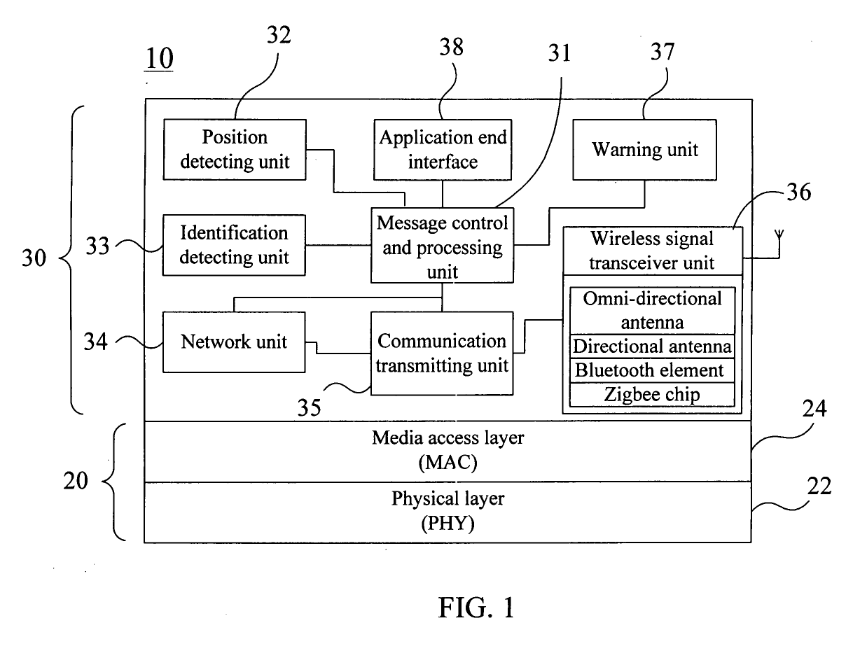

Referring to FIG. 1, a communication module 10 has a data linking platform 20 serving as a bottom layer, and an application platform 30, which is constructed in the data linking platform 20. More specifically, the data linking platform 20 adopts a physical layer (PHY) 22 and a media access layer (MAC) 24 satisfying the IEEE 802.15.4 standard specification.

The application platform 30 is composed of a plurality of firmware units. The application platform 30 includes a message control and processing unit 31, a position detecting unit 32, an identification detecting unit 33, a network unit 34, a communication transmitting unit 35 and a wireless signal transceiver unit 36. In addition, the application platform 30 may further include a warning unit 37 and at least one application end interface 38.

The message control and processing unit 31 has the function of integrating the messages of the units and the logic and computation functions so that multiple message processing and control procedures may be performed.

The position detecting unit 32 has an addressing function and is linked with the message control and processing unit 31.

The identification detecting unit 33 has the functions of group recognition and identification code recognition, and the identification detecting unit 33 is linked with the message control and processing unit 31.

The network unit 34 is the firmware with a TCP/IP communication protocol and is linked with the message control and processing unit 31.

The communication transmitting unit 35 is for transmitting and commanding a communication command. The wireless signal transceiver unit 36 includes a Bluetooth element 362 and/or a Zigbee chip 364. The wireless signal transceiver unit 36 is for receiving and transmitting a wireless signal and is linked with the communication transmitting unit 35. In addition, the wireless signal transceiver unit 36 further includes an omni-directional antenna 366 and at least one directional antenna 368.

The application end interface 38 capable of creating the specific extended application is linked with the message control and processing unit 31. The warning unit 37 is connected to the message control and processing unit 31 and can thereby control a warning indicator (not shown), such as a buzzer or a light emitting diode (LED).

The architecture of the communication module 10 of the invention has been disclosed hereinabove. The communication module 10 may form various mechanisms through the combination of the units and the applications of the arrangements. In addition, the arrangements between the various mechanisms can provide various functions for the product development and application. The mechanisms generated by the arrangements of the units of the communication module 10 will be illustrated in the following.

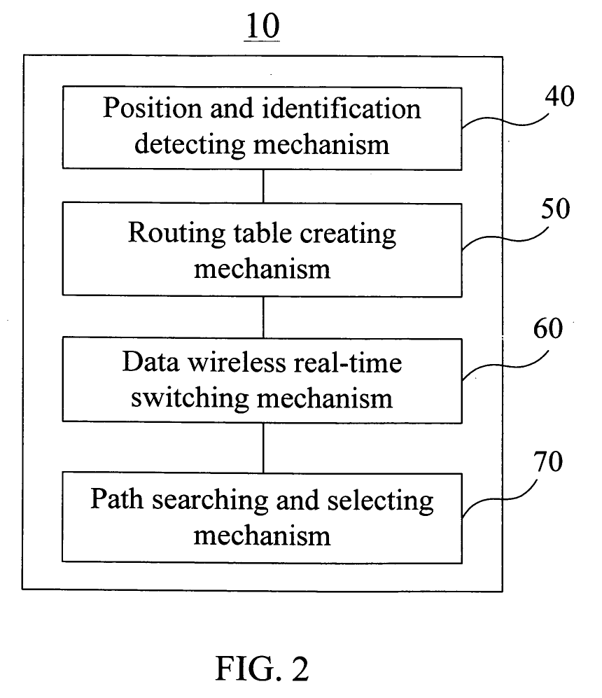

Referring to FIG. 2, the communication module 10 has a position and identification detecting mechanism 40, a routing table creating mechanism 50, a data wireless real-time switching mechanism 60 and a path searching and selecting mechanism 70. In other words, the method applied to the communication module 10 includes a position and identification detecting step, a routing table creating step, a data wireless real-time switching step and a path searching and selecting step.

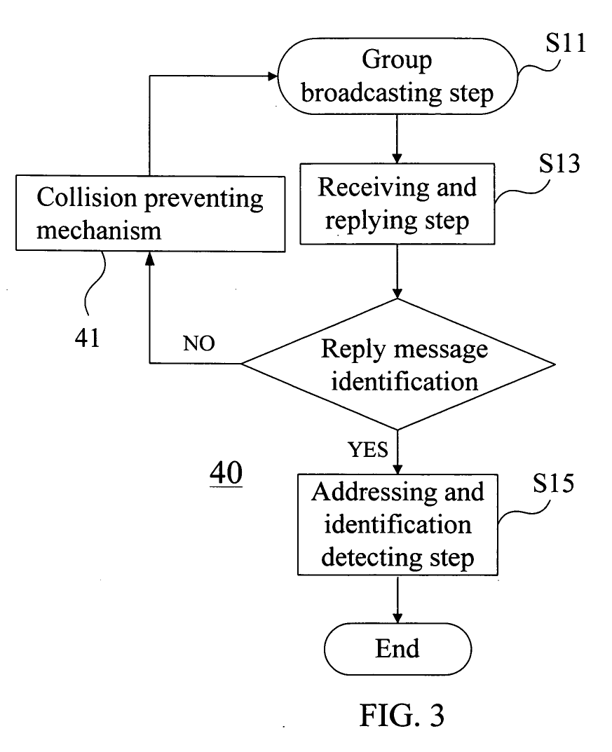

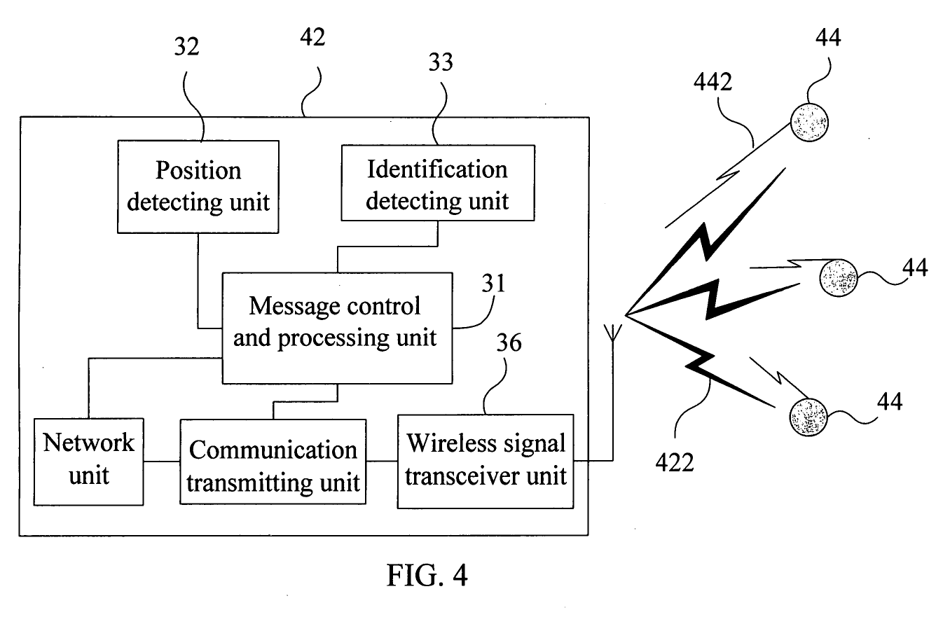

Referring to FIGS. 3 and 4, the position and identification detecting mechanism 40 includes the following steps.

In a group broadcasting step S11, a host device 42 performs group broadcasting to a plurality of client devices 44. The host device 42 has the communication module, so the message control and processing unit 31 and the wireless signal transceiver unit 36 cooperate with a notification message 422 to be outputted to the client devices 44.

In general, each of the host device 42 and the client device 44 has the communication module, and the notification message 422 has a group identification code, so a client device, which pertains to a different group, does not receive the notification message.

In a receiving and replying step S13, a reply message 442 is transmitted to the host device 42 after the client device 44 receives the notification message 422. When the host device 42 receives the reply message 442, it is further necessary to identify whether the message is sufficient for the detection.

In an addressing and identification detecting step S15, the reply message 442 is sufficient for the detection, multiple pieces of information (e.g., a beacon frame, an identification code and the like) contained in the reply message 442 are respectively transmitted to the position detecting unit 32 and the identification detecting unit 33 so that the addressing and identification detecting process of the client device 44 is performed.

It is to be noted that the host device 42 may do the group broadcasting according to the time interval mode (e.g., every 5 minutes) so that the notification message 422 is repeatedly transmitted, and the reply message 442 is repeatedly received. Thus, the effect of preventing the message from being lost can be achieved, and the automatic calling and reporting effect can be correspondingly formed according to the notification message 422 and the reply message 442.

However, when many reply messages 442 are simultaneously transmitted to the host device 42, the message congestion tends to occur to cause the loss of the reply messages 442. Therefore, a collision preventing mechanism 41 may be added to the process of identifying the reply message 442 to combine with the position and identification detecting mechanism 40.

The collision preventing mechanism 41 is to transmit the notification message 422 again when the host device 42 does not indeed receive the reply message 442 in order to increase the reliability of receiving the reply message 442. Thus, the message loss caused by the message congestion may be avoided.

In addition, the process of transmitting the notification message 422 again may be automatically made by the host device 42, which performs the group broadcasting according to the time interval mode.

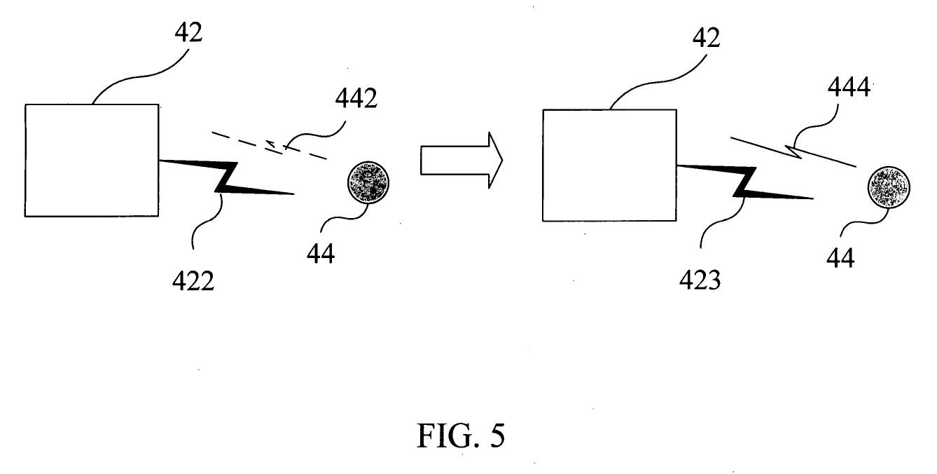

As shown in FIG. 5, another condition that may cause the loss of the reply message 442 is that the message strength is too weak so that the host device 42 judges that the client device 44 does not exist. In order to solve this problem, when the client device 44 receives a repeated notification message 423 outputted from the host device 42, the client device 44 actively replies an active reporting message 444 having a greater message strength to the host device 42 so that the actively reporting and identifying effect is achieved.

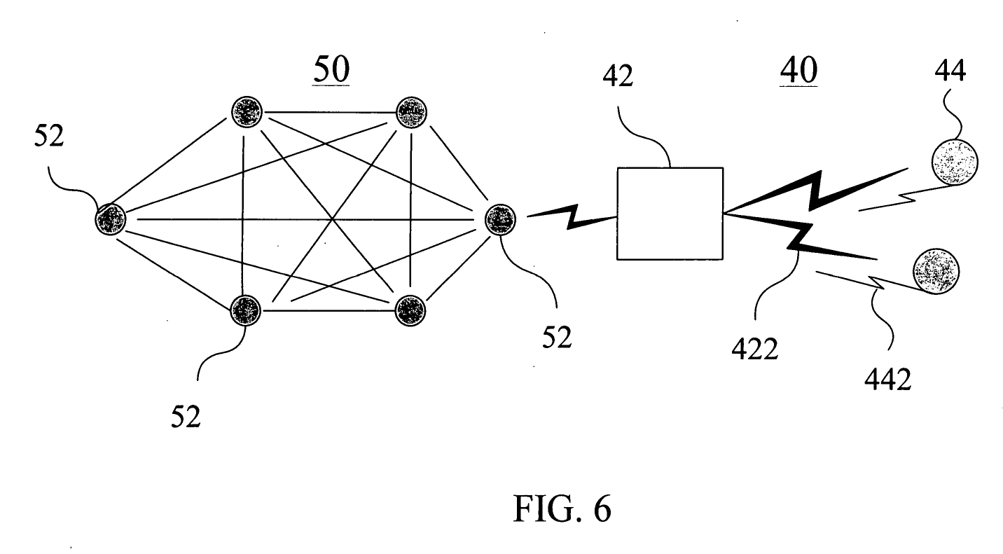

As shown in FIG. 6, the routing table creating mechanism 50 represents that the host device 42 actively creates the distribution diagram of each node 52 therearound.

More specifically speaking, the host device 42 adds or removes the nodes 52 in the peripheral environment of the host device 42 according to the periodic condition in conjunction with the position and identification detecting mechanism 40. Thus, the distribution relationships between the host device 42 and the nodes 52 construct a routing table.

It is to be noted that the message strengths between the nodes 52 and the host device 42 are not the same and IEEE 802.15.4 supports the full-function device (FFD) and the reduced-function device (RFD). So, the communication between the nodes 52 and the communication between the node 52 and the host device 42 have different formats.

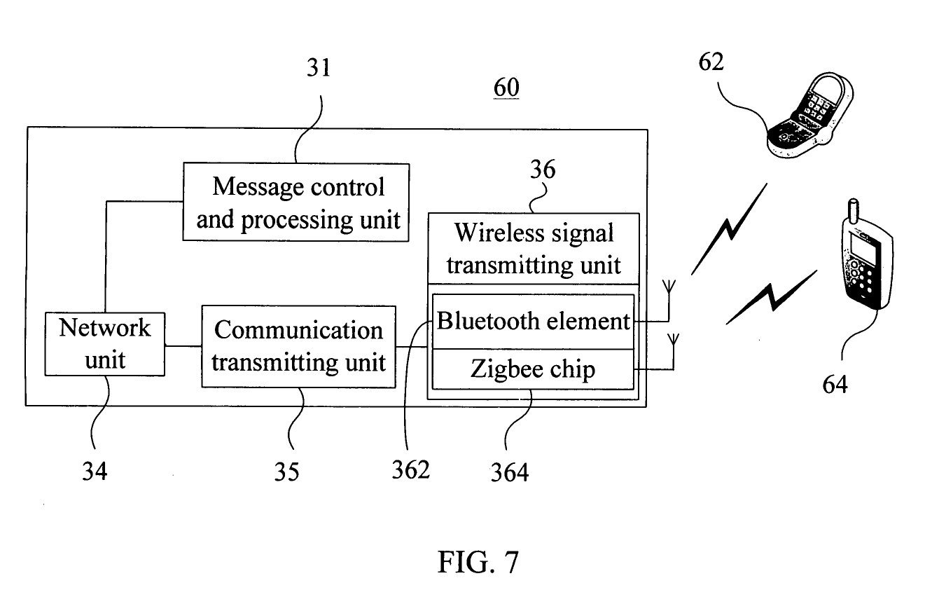

As shown in FIG. 7, the communication transmitting unit 35 commands a communication control command and performs the real-time data exchange with other wireless module interfaces in the data wireless real-time switching mechanism 60. For example, the communication transmitting unit 35 commands the communication control command, such as SMS or DATA PACKAGE, and divides and reconstructs the packet in conjunction with the TCP/IP protocol of the network unit 34. Then, the wireless signal transceiver unit 36 transmits the message out, wherein the Bluetooth element 362 can transmit the message to a mobile telephone 62 having a Bluetooth device at a remote end or a local end, or the Zigbee chip 364 can transmit the message to a hand-held wireless device 64 having a Zigbee unit. The above-mentioned data includes agreements or file formats, such as VOIP, DATA, IMAGE or FILE, which may be transmitted through the network transmission.

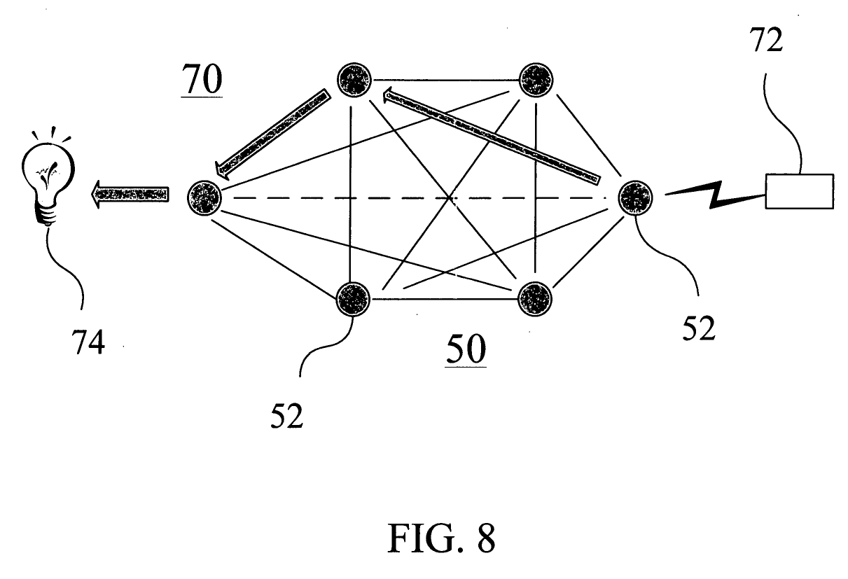

As shown in FIG. 8, the path searching and selecting mechanism 70 represents the mechanism of searching and selecting a message transmission path between two terminal devices 72 and 74. The path between the two terminal devices 72 and 74 may be a routing table created by the routing table creating mechanism 50, and the received signal strength indicator (RSSI) between the terminal device 72 and the node 52 may serve as one reference for the determination of the priority of the transmission path. In addition, the priority of the transmission path may also be determined according to the distance cost. Therefore, the message between the two terminal devices 72 and 74 may be transmitted through the optimum path determined according to the priority.

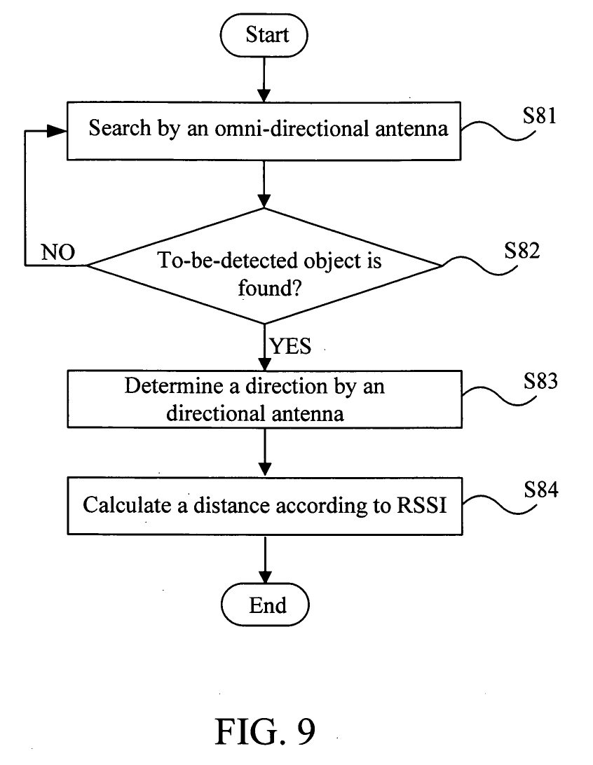

FIG. 9 is a flow chart showing a mechanism of determining a direction and a distance of a to-be-detected end according to the invention. The mechanism includes the following steps.

In step S81, the detecting end uses an omni-directional antenna to perform the omi-directional search in the ambient environment, wherein the detecting end may be a hand-held device held by a user and the hand-held device may perform the detection by way of group broadcasting.

In step S82, it is determined whether the to-be-detected object is found or not. The to-be-detected object may have a device with an omni-directional antenna, so the detecting end and the to-be-detected end may have the signal connection therebetween. In other words, the to-be-detected end can generate a reply message and output the reply message to the detecting end. However, because the omni-directional antenna transmits the message using the local area wireless network, it has the limitation of the transmitting distance. When the detecting end receives the message of the to-be-detected end, the next step is performed.

In step S83, the direction is determined by the directional antenna. It is to be noted that the detecting end may be a user who is moving or exercising. So, if there is one directional antenna or there are two directional antennas, the direction of the to-be-detected end is determined according to the moving direction of the user. If there are three directional antennas, the user may use the distribution angle of each directional antenna to determine the direction of the to-be-detected end in the stationary condition.

In step S84, the distance from the to-be-detected end to the detecting end is determined according to the received signal strength indicator (RSSI) serving as the reference value for the calculation of the distance.

Consequently, each of the units and the combination of the units of the application platform 30 may provide the position detection, the identification detection and the real-time information exchange, can transmit information through the optimum path, and has the effect of preventing the information from being lost. Therefore, the application end interface 38 and the suitable application device or sensor can achieve the effects of information wireless transmission and recognition, and the positioning effect. The home or building automatic control or security, the personal health management, the industry or factory control, the telecommunication service, the connection between the computer and its peripheral apparatus, or the positioning of the human, the vehicle or the object may be implemented by the communication module and each mechanism thereof.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A smart data dynamic communication module, comprising:
a data linking platform;
an application platform having a message control and processing unit, a position detecting unit, an identification detecting unit, a network unit, a communication transmitting unit and a wireless signal transceiver unit, wherein:
the application platform is constructed in a wireless network platform;
the message control and processing unit has functions of information integration, logic control and computation;
the position detecting unit has an addressing function and is linked to the message control and processing unit;
the identification detecting unit has a function of recognizing a group and an identification code and is linked to the message control and processing unit;
the network unit has a network communication protocol and is linked to the message control and processing unit;
the communication transmitting unit is for transmitting and commanding a network communication command;
the wireless signal transceiver unit is for receiving a wireless signal and is linked to the communication transmitting unit.

2. The smart data dynamic communication module according to claim 1, wherein the data linking platform comprises a physical layer and a media access control layer satisfying an IEEE 802.15.4 standard specification.

3. The smart data dynamic communication module according to claim 1, wherein the network unit has a TCP/IP communication protocol.

4. The smart data dynamic communication module according to claim 1, wherein the wireless signal transceiver unit is a Bluetooth unit.

5. The smart data dynamic communication module according to claim 1, wherein the wireless signal transceiver unit is a Zigbee chip.

6. The smart data dynamic communication module according to claim 1, wherein the wireless signal transceiver unit comprises an omni-directional antenna and at least one directional antenna.

7. The smart data dynamic communication module according to claim 1, further comprising a warning unit, which is for providing transmitting and receiving control of a warning message and is linked to the message control and processing unit.

8. The smart data dynamic communication module according to claim 1, further comprising at least one application end interface linked to the message control and processing unit.

9. A message processing and transmitting method of a communication module, the method comprising:
a position and identification detecting step, in which a host device performs group broadcasting to at least one client device, the client device transfers back a reply message to the host device, and a position detecting unit and an identification detecting unit of the host device perform a positioning and identification detecting process;
a routing table creating step, in which the host device adds or removes peripheral nodes under a periodic condition in conjunction with the position and identification detecting step;
a data wireless real-time switching step, in which a communication transmitting unit commands a communication control command and performs a real-time data exchange operation with other wireless module interfaces;
a path searching and selecting step, in which an optimum path for a transmission message to travel is selected according to a routing table created by the routing table creating step in conjunction with a priority access principle.

10. The method according to claim 9, wherein in the position and identification detecting step, the group broadcasting transmits a message in a timing interval mode.

11. The method according to claim 9, further comprising a collision preventing step, in which the group broadcasting is repeatedly performed to the client device when the host device cannot receive the reply message of the client device.

12. The method according to claim 9, further comprising an active reporting step, in which the client device actively replies an active reporting message to the host device when the reply message of the client device cannot be identified by the host device.

13. The method according to claim 9, wherein the priority access principle comprises determination of a priority of a transmission path according to a distance cost.

14. The method according to claim 9, wherein the priority access principle comprises determination of a priority of a transmission path according to a received signal strength indicator.

15. The method according to claim 9, further comprising a relative position detecting step for a to-be detected and a detecting end, wherein the to-be-detected end is determined according to the group broadcasting in the position and identification detecting step and according to the reply message, the wireless module is controlled by the data wireless real-time switching step to detect a direction of the to-be-detected end, and a distance from the detecting end to the to-be-detected end is determined according to the received signal strength indicator.

16. The method according to claim 15, wherein the wireless module comprises an omni-directional antenna and at least one directional antenna.
